(19) United States
(12) Patent Application Publication
(10) Pub. No.: US 2012/0011467 A1
(43) Pub. Date: Jan. 12, 2012

(54) Window Opening and Arranging Method

(75) Inventor: Yi-Chen Sung, Taipei City (TW)

(73) Assignee: COMPAL ELECTRONICS, INC., Taipei City (TW)

(21) Appl. No.: 12/901,710

(22) Filed: Oct. 11, 2010

(30) Foreign Application Priority Data
Jul. 6, 2010 (TW) 99122215

(51) Int. Cl. G06F 3/048

(52) U.S. Cl. 715/788

(57) ABSTRACT

A window opening and arranging method adapted in a computer system is provided. The method comprises the steps as follow. A window on a screen of the computer system is provided. A continuous touch signal passing two sides of the window inputted from a command input module is detected. A relative position of the continuous touch signal with respect to the window is computed. A window allocation data is determined according to the relative position of the continuous touch signal. The window is split into a first window and a second window according to the window allocation data.

### RELATED APPLICATIONS

This application claims priority to Taiwan Application Ser. No. 99122215, filed Jul. 6, 2010, which is herein incorporated by reference.

### BACKGROUND

1. Technical Field

The present invention relates to an electronic data processing method. More particularly, the present invention relates to a window opening and arranging method.

2. Description of Related Art

Computer is one of the most important inventions in 20th century. Command-line interface (CLI) and graphical user interface (GUI) are the mechanisms for interacting with a computer. In comparison with CLI, GUI becomes the mainstream technology since graphics are more intuitive to the user. In GUI technology, window plays an important role and becomes the most common kind of graphical interface.

Usually, each window on the screen corresponds to an application program interface. However, when the user feels like to open a new window to run a specific application program, the user has to search for the shortcut of the application program from the start menu or from its sub-menus, which is time-consuming and not intuitive.

Accordingly, what is needed is a window opening and arranging method that is able to open the window quickly and intuitively. The present disclosure addresses such a need.

### SUMMARY

An aspect of the present disclosure is to provide a window opening and arranging method adapted in a computer system. The method includes the steps as follow. A window on a screen of the computer system is provided. A continuous touch signal passing two sides of the window inputted from a command input module is detected. A relative position of the continuous touch signal with respect to the window is computed. A window allocation data is determined according to the relative position of the continuous touch signal. The window is split into a first window and a second window according to the window allocation data.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiments, with reference made to the accompanying drawings as follows:

FIG. 1A and FIG. 1B is a block diagram of a computer system of an embodiment of the present disclosure;

FIG. 2 is flow chart of a window opening and arranging method in an embodiment of the present disclosure;

FIG. 3A to FIG. 3D depict the process of the window opening and arranging method;

FIG. 4 is flow chart of a window opening and arranging method in an embodiment of the present disclosure;

FIG. 5A to FIG. 5D depict the process of the window opening and arranging method; and

FIG. 6A and FIG. 6B depict the windows that is opened and arranged by the window opening and arranging method described above

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

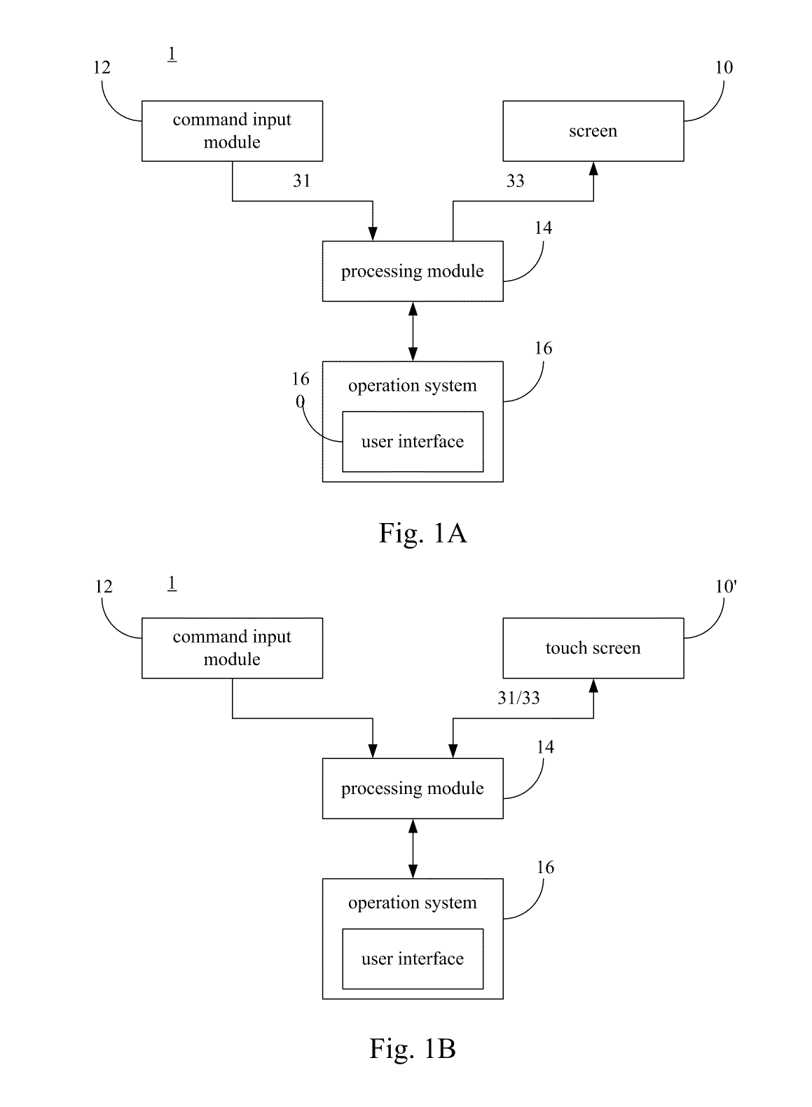

Please refer to FIG. 1A. FIG. 1A is a block diagram of a computer system 1 of an embodiment of the present disclosure. The computer system 1 includes a screen 10, a command input module 12, a processing module 14 and an operation system 16.

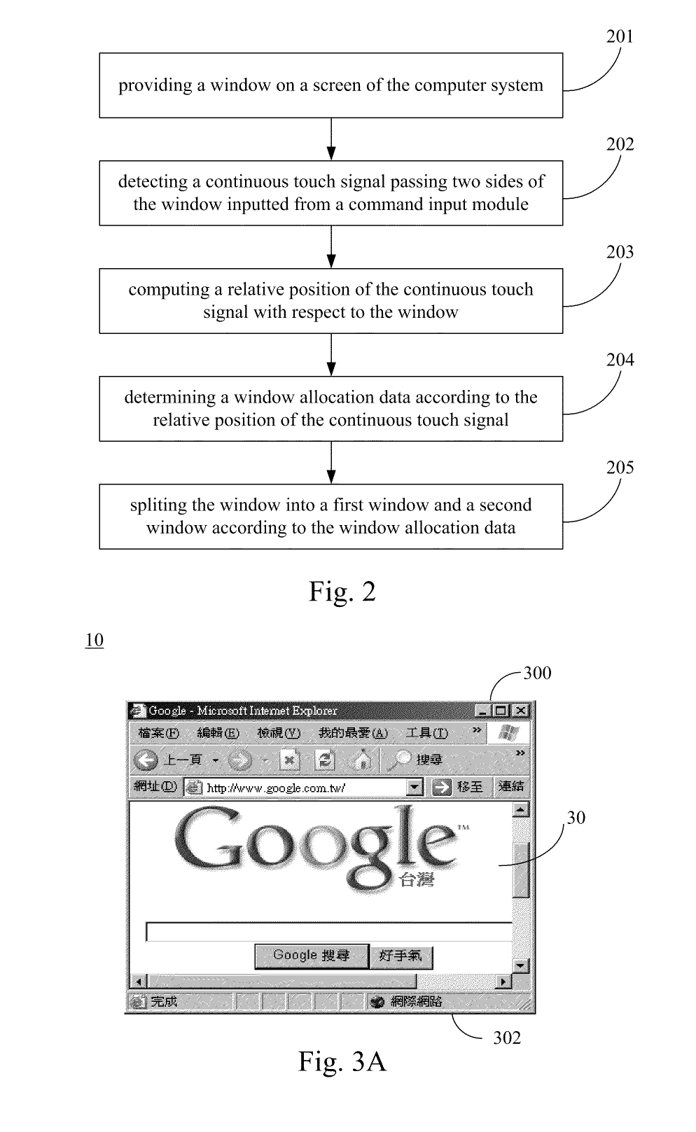

Please refer to FIG. 2 at the same time. FIG. 2 is flow chart of a window opening and arranging method in an embodiment of the present disclosure. The window opening and arranging method is adapted in the computer system 1 depicted in FIG. 1A. Substantially, the window opening and arranging method is adapted in the screen 10 of the computer system 1 to provide the user a method to open the window quickly and intuitively. (The steps are not recited in the sequence in which the steps are performed. That is, unless the sequence of the steps is expressly indicated, the sequence of the steps is interchangeable, and all or part of the steps may be simultaneously, partially simultaneously, or sequentially performed).

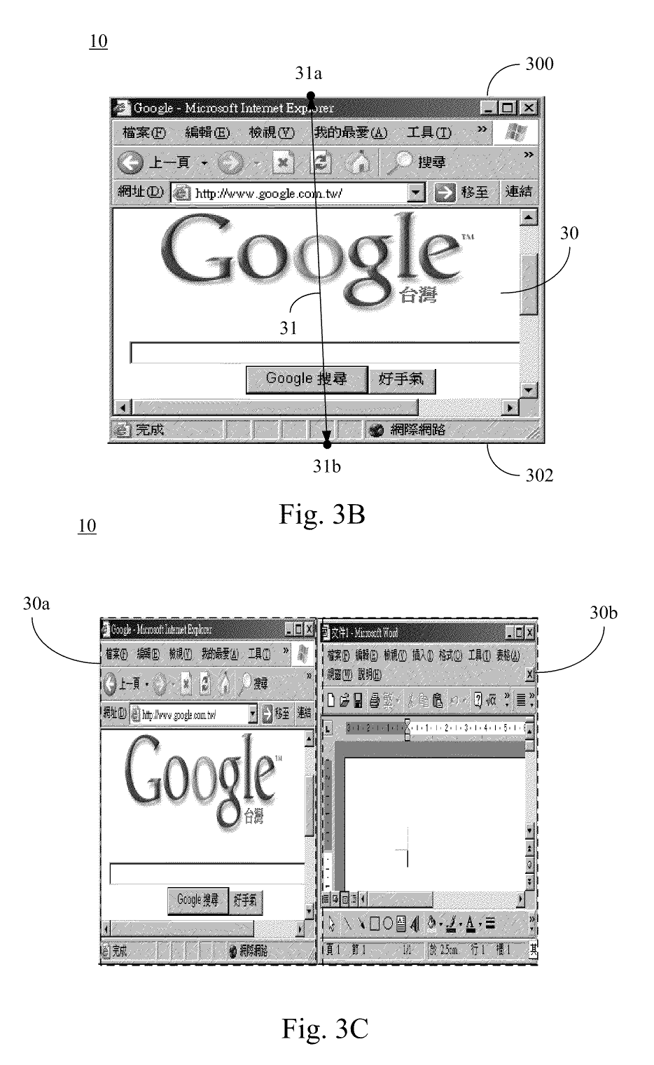

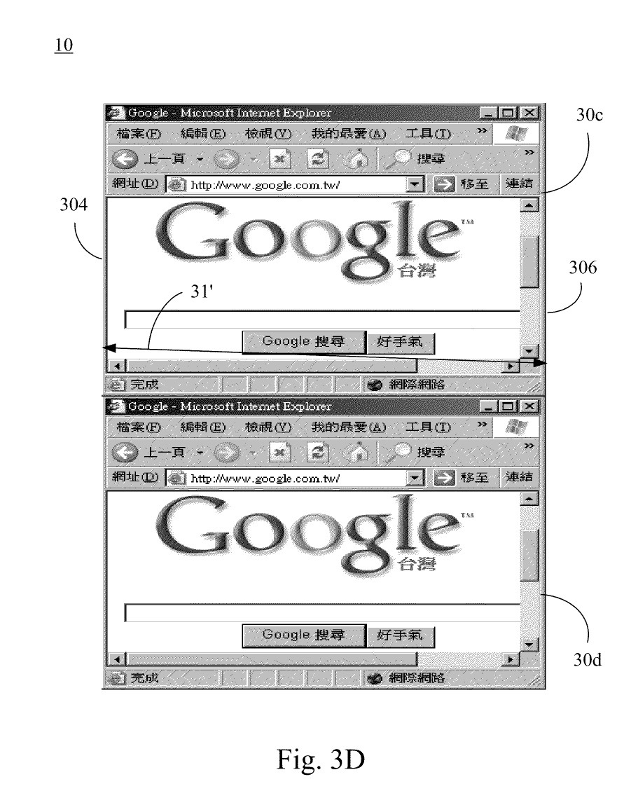

Please refer to FIG. 3A to FIG. 3D as well, wherein FIG. 3A to FIG. 3D depict the steps of the process of the window opening and arranging method. The window opening and arranging method includes the steps as follows. In step 201, a window 30 is provided on the screen 10 of the computer system 1 in FIG. 1A. It's noticed that though only one window 30 is shown in FIG. 3A, there can be several windows displayed on the screen 10 at the same time in other embodiments.

A continuous touch signal 31 passing two sides of the window 30 inputted from the command input module 12 is detected in step 202. In the present embodiment, the command input module 12 is a mouse. Substantially, input modules with functions similar to the mouse such as a track ball or a combination of touch pad and input keys can be used as well. Accordingly, the continuous touch signal 31 is a track signal corresponding to a displacement of the mouse in the present embodiment. The processing module 14 shown in FIG. 1A can detect the position of the mouse cursor and its movement relative to the window 30 on the screen 10 that is controlled by the command input module 12. In an embodiment, the track signal can be detected by the displacement of the mouse solely. In another embodiment, the track signal can only be detected when a press on the button of the mouse and the displacement of the mouse are both sensed.

As shown in FIG. 3B, the track passes the two sides 300 and 302 of the window 30. The track of the continuous touch signal 31 detected by the processing module 14 is the line shown in FIG. 3B stretching from the interception point 31a on the side 300 to the interception point 31b on the side 302.

In another embodiment, as shown in FIG. 1B, the screen of the computer system 1 is substantially a touch screen 10′. Consequently, the processing module 14 not only detects the input from the command input module 12 but also detects the touch input from the touch screen 10′. Thus, the continuous touch signal 31 can be a touch signal corresponding to a displacement of the touch input from the touch screen 10′ performed by a hand or an object moving from one side to another side of the screen 30.

In an embodiment, when the processing module 14 detects the continuous touch signal 31, it further shows a track line on the window 30 according to the track signal.

In step 203, a relative position of the continuous touch signal 31 with respect to the window 30 is computed. Thus, the relative position and direction of the track on the windows can be obtained. A window allocation data 33 is determined by the processing module 14 in step 204 according to the relative position of the continuous touch signal 31 mentioned above. Then in step 205, the window 30 is split into a first window 30a and a second window 30b according to the window allocation data 33, as shown in FIG. 3C.

For example, the track stretching from the side 300 to the side 302 is commonly considered to be in a substantially vertical direction. Thus, the processing module 14 determines the window allocation data 33 according to the continuous touch signal 31 that is in the substantially vertical direction, to split the window into a first window 30a and a second window 30b, wherein the first window 30a and the second window 30b are allocated in a relative left-right order, as shown in FIG. 3C. Please refer to FIG. 3D. FIG. 3D is another diagram depicting the window that is divided according to window allocation data 33 that is determined according to the continuous touch signal 31′ in a substantially horizontal direction. The track stretching from the side 304 to the side 306 of the window 30 is commonly considered to be in a substantially horizontal direction. Thus, the processing module 14 determines the window allocation data 33 according to the continuous touch signal 31′ that is in the substantially horizontal direction, to split the window into a first window 30c and a second window 30d in a top-down order, as shown in FIG. 3D.

It's noticed that the term “substantially vertical” and the term “substantially horizontal” used in the above paragraph mean that the track may not be exactly vertical or horizontal and may have an angle slightly different from the exactly vertical or horizontal direction.

In an embodiment, the window 30 is evenly split into the first window 30a (or 30c) and the second window 30b (or 30d). In other embodiments, the window is split into the first and the second windows by a specific ratio according to the window allocation data 33, wherein the window allocation data 33 may include the dimension and the coordinates of each of the first and the second windows. It will be apparent to those skilled in the art that various modifications and variations can be made to the structure of the present invention without departing from the scope or spirit of the invention.

The operation system 16 provides the user interface 160 of the application program and the user interface 160 is displayed in the window 30. In an embodiment, the window 30 displays a first application program interface and after being split, the first window 30a displays the first application program interface and the second window 30b displays a default application program interface, as shown in FIG. 3C. In another embodiment, the first window 30c and the second window 30d can both display the first application program interface, as shown in FIG. 3D. It's noticed that the position of the first and the second windows can exchange with each other in both FIG. 3C and FIG. 3D.

The window opening and arranging method in the present embodiment is able to detect the continuous touch signal 31 or 31′ and split the original window 30 according to the continuous touch signal 31 or 31′.

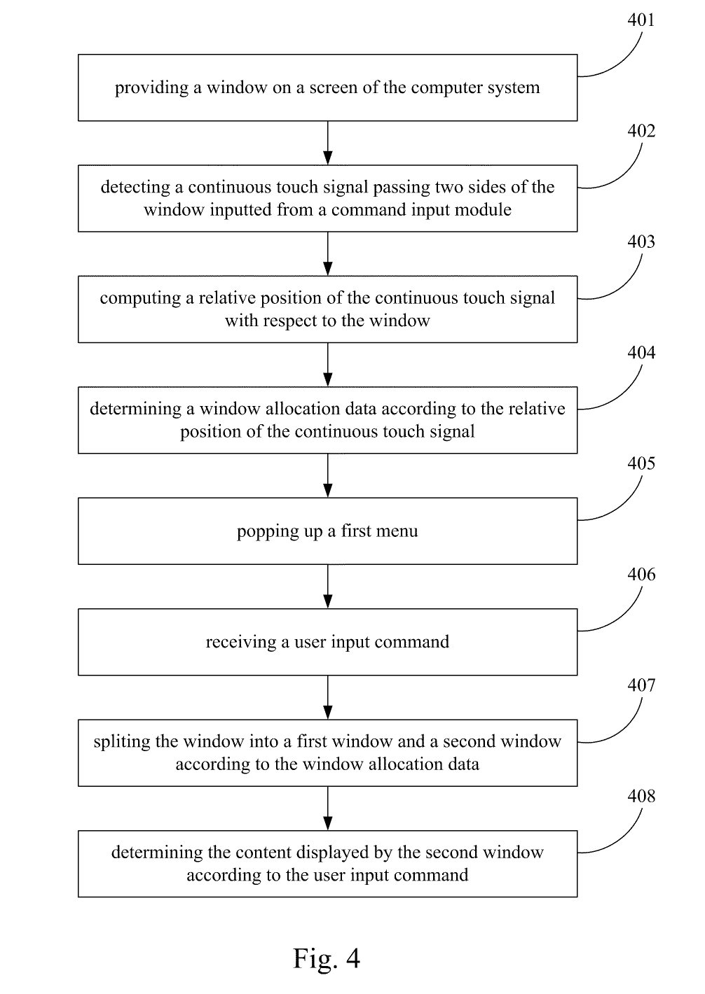

Please refer to FIG. 4 at the same time. FIG. 4 is flow chart of a window opening and arranging method in an embodiment of the present disclosure. The window opening and arranging method is adapted in the computer system 1 depicted in FIG. 1A. Substantially, the window opening and arranging method is adapted in the screen 10 of the computer system 1 to provide the user a method to open the window quickly and intuitively. (The steps are not recited in the sequence in which the steps are performed. That is, unless the sequence of the steps is expressly indicated, the sequence of the steps is interchangeable, and all or part of the steps may be simultaneously, partially simultaneously, or sequentially performed).

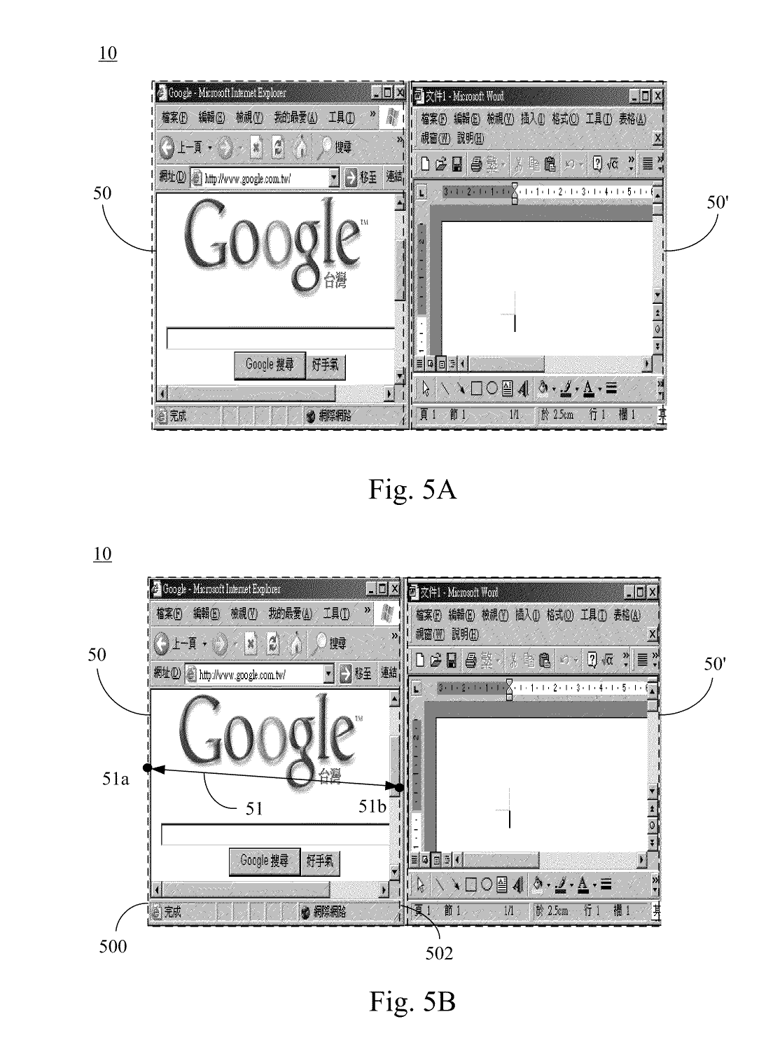

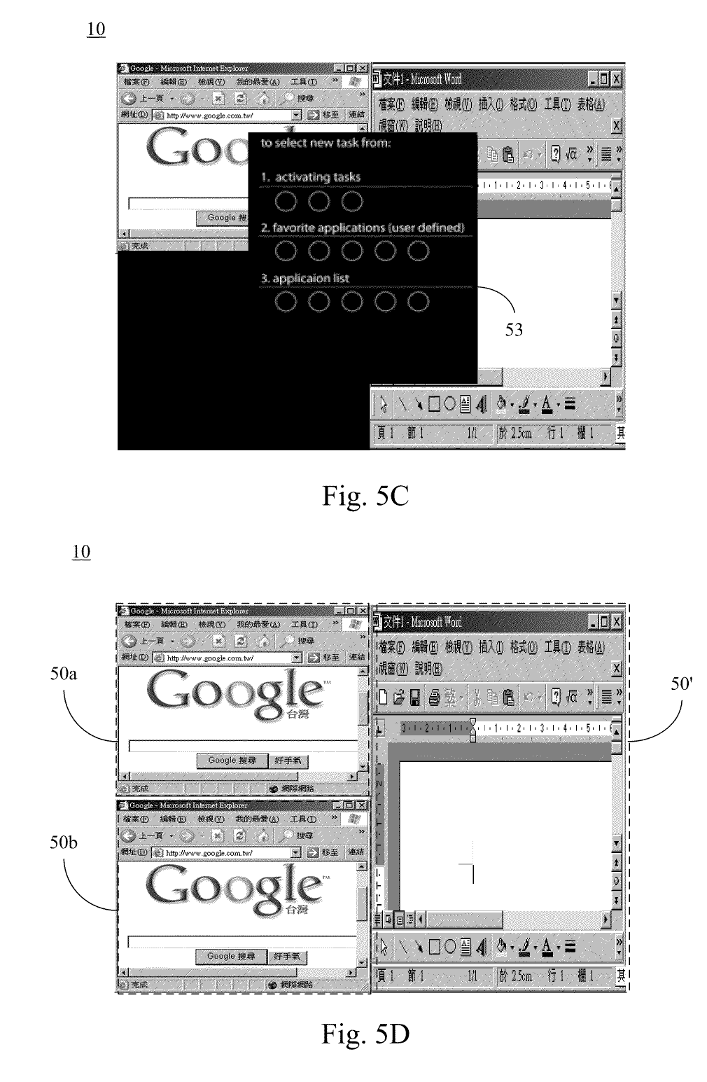

Please refer to FIG. 5A to FIG. 5D as well, wherein FIG. 5A to FIG. 5D depict the process of the window opening and arranging method. The window opening and arranging method includes the steps as follows. As shown in FIG. 5A, two windows 50 and 50′ are provided on the screen 10 of the computer system 1 in FIG. 1A in step 401. A continuous touch signal 51 passing two sides of the window 50 inputted from the command input module 12 is detected in step 402, as shown in FIG. 5B. The continuous touch signal 51 in the present embodiment passes two sides 500 and 502 of the window 50. Substantially, the continuous touch signal 51, which is a track signal as well, is formed from the interception point 51a on the side 500 along the line depicted on FIG. 5B to the interception point 51b on the side 502. On the contrary, it can also be formed from the interception point 51b along the line depicted on FIG. 5B to the interception point 51a.

In step 403, a relative position of the continuous touch signal 51 with respect to the window 50 is computed. Thus, the relative position and direction of the track on the windows can be obtained. A window allocation data is determined in step 404 according to the relative position of the continuous touch signal 51 mentioned above.

Then in step 405, a first menu 53 is popped up, as shown in FIG. 5C. The first menu may include a menu of application programs in active windows, a menu of favorite list and a menu of all application programs. In an embodiment, the menu of application programs in active windows is to provide the options of the interface of the application programs shown in existing windows for the user to select, such as the interface of the application programs in windows 50 and 50′ depicted in FIG. 5A. In other words, the menu shows the application programs in the windows that are active or currently in use or currently open when the window splitting process is performing. The menu of favorite list simply displays a list of application programs set by the user. The menu of all application programs displays all the application programs in the computer system 1. It's noticed that in other embodiments, various menus can be used to make the user perform the selection.

In step 406, the computer system 1 receives a first user input command selecting an item from the first menu (not shown). The window 50 is divided into a first window 50a and a second window 50b according to the window allocation data computed in step 404, as shown in FIG. 5D in step 407. In step 408, the content displayed by second window 50b is determined according to the first user input command, whereas the first window 50a displays the first application program that is displayed by window 50 previously. In other embodiment, the content displayed by the first window 50a can be determined by other methods as well. Further, the position of the first and the second windows can exchange with each other as well.

In an embodiment, when the first user input command is not received within a predetermined time interval in step 406, a second menu is popped up to request a second user input command indicating whether to terminate the step of splitting the window 50.

The window opening and arranging method in the present embodiment further allows the user to select the content displayed by the split window. Further, when the selection command is not received, the second menu can make the user decide whether the window splitting process is to be terminated or not, providing the user a more flexible and convenient way to control the window splitting process. It's noticed that, the window opening and arranging method in the present embodiment can be adapted to the screen 10′ depicted in FIG. 1B as well.

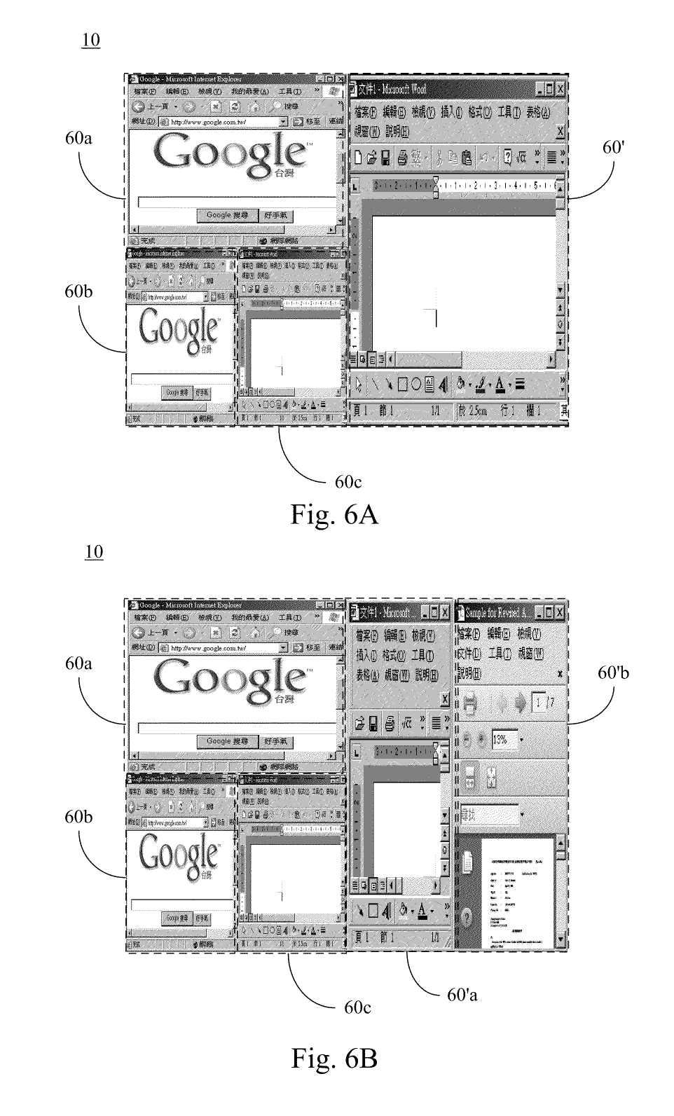

Please refer to FIG. 6A and FIG. 6B. FIG. 6A and FIG. 6B depict the windows that is opened and arranged by the window opening and arranging method described above. The user can split the windows shown in FIG. 5B into windows 60a, 60b, 60c and 60′depicted in FIG. 6A, or further, the user can divide the windows shown in FIG. 6A into 60a, 60b, 60c, 60′a and 60′b depicted in FIG. 6B.

It's noticed that the track of the continuous touch signal in the above embodiments passes the two opposite sides of the window, such as left/right sides or top/down sides of the window. In other embodiments, the track of the continuous touch signal passing two neighboring sides can be detected as well, such as the left/down sides, the right/top sides, the left/top sides and the right/down sides.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A window opening and arranging method adapted in a computer system comprising the steps of:
providing a window on a screen of the computer system;
detecting a continuous touch signal passing two sides of the window inputted from a command input module;
computing a relative position of the continuous touch signal with respect to the window;
determining a window allocation data according to the relative position of the continuous touch signal; and
splitting the window into a first window and a second window according to the window allocation data.

2. The window opening and arranging method of claim 1, wherein the continuous touch signal is a track signal of a displacement passing the two sides of the window.

3. The window opening and arranging method of claim 2, wherein the command input module is a mouse and the track signal is a mouse signal corresponding to a displacement of the mouse.

4. The window opening and arranging method of claim 2, wherein the screen is a touch screen, the command input module is the touch screen and the track signal is a touch signal corresponding to a displacement of a touch input.

5. The window opening and arranging method of claim 1, wherein the window allocation data is to evenly split the window into the first window and the second window.

6. The window opening and arranging method of claim 2, wherein the window allocation data is to split the window into the first window and the second window according to a direction of the track signal.

7. The window opening and arranging method of claim 6, wherein when the direction is considered vertical, the first window and the second window are allocated in a relative left-right order.

8. The window opening and arranging method of claim 6, wherein when the direction is considered horizontal, the first window and the second window are allocated in a relative top-down order.

9. The window opening and arranging method of claim 1, wherein when the window displays a first application program interface, the first window and the second window both display the first application program interface.

10. The window opening and arranging method of claim 2, wherein the step of detecting the continuous touch signal further comprises showing a track line on the window according to the track signal.

11. The window opening and arranging method of claim 1, further comprising the following steps:
popping up a first menu;
receiving a first user input command selecting an item on the first menu; and
determining the content to be displayed by the second window according to the first user input command.

12. The window opening and arranging method of claim 11, wherein when the window displays a first application program interface, the first window displays the first application program interface.

13. The window opening and arranging method of claim 11, further comprising popping up a second menu when the user input command is not received within a predetermined time interval to request a second user input command indicating whether to terminate the step of splitting the window.

14. The window opening and arranging method of claim 11, wherein the first menu comprises a menu of application programs in active windows, a menu of favorite list and a menu of all application programs.

15. The window opening and arranging method of claim 1, wherein the window allocation data comprises a size and a coordinate of each of the first and the second windows.
